(19) United States
(12) Patent Application Publication
(10) Pub. No.: US 2022/0374360 A1
(43) Pub. Date: Nov. 24, 2022

(54) MEMORY DEVICE AND METHOD FOR ACCESSING MEMORY DEVICE

(71) Applicant: MACRONIX International Co., Ltd., Hsinchu (TW)

(72) Inventors: Ting-Yu Liu, Hsinchu City (TW); Chang-Hao Chen, Hsinchu City (TW)

(73) Assignee: MACRONIX International Co., Ltd., Hsinchu (TW)

(21) Appl. No.: 17/323,829

(22) Filed: May 18, 2021

(51) Int. Cl. G06F 12/0873; G06F 12/0891; G06F 12/02; G06F 12/123

(52) U.S. Cl. CPC G06F 12/0873; G06F 12/0891; G06F 12/0292; G06F 12/0246; G06F 12/123; G06F 2212/7201

(57) ABSTRACT

The invention provides a memory device including a memory array, an internal memory, and a processor. The memory array stores node mapping tables for access data in the memory array. The internal memory includes a cached mapping table area and has a root mapping table. The processor determines whether a first node mapping table of the node mapping tables is temporarily stored in the cached mapping table area according to the root mapping table. In response to the first node mapping table is temporarily stored in the cached mapping table area, the processor accesses data according to the first node mapping table in the cached mapping table area, marks the modified first node mapping table through an asynchronous index identifier, and writes back the modified first node mapping table from the cached mapping table area to the memory array.

### BACKGROUND

### Technical Field

The present disclosure relates to a memory device and a method for accessing the memory device to shrink capacity of the internal memory in the memory device and to reduce power consumption of the memory device.

### Description of Related Art

With the development of technology, capacity of storage devices may become larger and larger, and therefore larger internal memory of the storage devices may be required for managing data access. Based on general design for the capacity of the storage devices, the capacity of the internal memory is usually one thousandth of the overall capacity of the storage devices. However, because commonly used data occupies only a small part of all capacity of internal memory, the utilization rate of internal memory is poor. In addition, a larger capacity internal memory requires a higher cost, and the memory cells in the internal memory must be refreshed periodically resulting in power consumption. As the capacity of storage device will continue to increase as technology evolves, how to optimize the utilization rate of internal memory for increasing a hit rate of data access, thereby reducing the power consumption of the storage devices, is one of the research directions for the storage devices.

### SUMMARY

The present invention provides a memory device and a method for accessing the memory device by caching part of the node mapping tables to an internal memory for shrinking capacity of the internal memory of the memory device and reducing power consumption of the memory device.

The memory device in the present invention includes a memory array, an internal memory, and a processor. The memory array stores a plurality of node mapping tables for access data in the memory array. The internal memory includes a cached mapping table area, and the internal memory has a root mapping table. The cached mapping table area temporarily stores a part of the cached node mapping tables of the memory array. The processor is coupled to the memory array and the internal memory. The processor determines whether a first node mapping table of the node mapping tables is temporarily stored in the cached mapping table area according to the root mapping table. In response to the first node mapping table is temporarily stored in the cached mapping table area, the processor accesses data according to the first node mapping table in the cached mapping table area, and marks the modified first node mapping table through an asynchronous index identifier. And, the processor writes back the modified first node mapping table from the cached mapping table area to the memory array according to the root mapping table and the asynchronous index identifier.

The method for accessing the memory device in the present invention is applicable to the memory device including a memory array and an internal memory. The method includes following steps: determining whether a first node mapping table of a plurality of node mapping tables is temporarily stored in a cached mapping table area of the internal memory according to a root mapping table, wherein the plurality of node mapping tables is stored in the memory array, the root mapping table is included in the internal memory, and the cached mapping table area temporarily stores a part of the cached node mapping tables of the memory array; in response to the first node mapping table is temporarily stored in the cached mapping table area, accessing data according to the first node mapping table in the cached mapping table area; marking the modified first node mapping table through an asynchronous index identifier; and, writing back the modified first node mapping table from the cached mapping table area to the memory array according to the root mapping table and the asynchronous index identifier.

The method for accessing the memory device in the present invention includes following steps: determining whether a first node mapping table of a plurality of node mapping tables is temporarily stored in a cached mapping table area of an internal memory according to a root mapping table, wherein the plurality of node mapping tables is stored in a memory array of the memory device, and the root mapping table is included in the internal memory, and the cached mapping table area does not temporarily store all of the node mapping tables in the memory array at the same time; in response to the first node mapping table is temporarily stored in the cached mapping table area, accessing data according to the first node mapping table in the cached mapping table area; and, synchronizing the modified first node mapping table from the cached mapping table area to the memory array.

Based on the foregoing, the memory device and the method for accessing therefore in the embodiments of the present invention is configured to access data by a root mapping table for guiding all node mapping tables is in the cached mapping table area of the internal memory or in the memory array. If current data may use the node mapping table in the memory array rather than in the internal memory, the memory device caches the node mapping table from the memory array to the internal memory, so that the capacity of the internal memory in the memory device is shirked, the cost of the memory is decreased and power consumption of the memory device is reduced. In other words, a part of the cached node mapping tables is cached in the internal memory rather than all of the node mapping tables been cached in the internal memory. And, the memory device in the embodiments of the present invention manages the synchronization between the node mapping tables in the memory array and the cached node mapping tables in the internal memory rapidly by the asynchronous index identifier and the root mapping table. And, the memory device in the embodiments of the present invention applies some strategies to improve the hit rate for accessing data by cached node mapping tables in the internal memory according to temporal and spatial locality.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a block diagram of an electronic system with a host device and a memory device according to an embodiment of the present invention.

FIG. 2 is a schematic diagram of the root mapping table, the cached NMT(s), the data structure of the memory array, and information of the asynchronous index identifier according to an embodiment of the present invention.

FIG. 3 is a flow chart illustrating a method for accessing the memory device according to an embodiment of the present invention.

FIG. 4A and FIG. 4B is a flow chart and a schematic diagram for mapping table management initialization of the memory device according to an embodiment of the present invention respectively.

FIG. 5A and FIG. 5B is a flow chart and a schematic diagram for lookup logic-to-physical (L2P) entry operation of the memory device according to an embodiment of the present invention respectively.

FIG. 6A and FIG. 6B is a flow chart and a schematic diagram for a swap map table operation of the memory device according to an embodiment of the present invention.

FIG. 7A and FIG. 7B is a flow chart and a schematic diagram for update L2P entry operation of the memory device 100 according to an embodiment of the present invention respectively.

FIG. 8A and FIG. 8B is a flow chart and a schematic diagram for the synchronize map table operation of the memory device 100 according to an embodiment of the present invention.

FIGS. 9A and 9B are schematic diagrams illustrating different structures of data mapping tables in the memory according to some embodiments of the present invention.

### DESCRIPTION OF THE EMBODIMENTS

Implementations of the present disclosure provide systems and methods for accessing data by a root mapping table to guide all node mapping tables is in the cached mapping table area of the internal memory or in the memory array. For example, a part of the cached node mapping tables is cached in the internal memory rather than all of the node mapping tables been cached in the internal memory, thus the capacity of the internal memory in the memory device may be shirked. In other words, some of the node mapping tables are cached from the memory array of the memory device to the internal memory of the memory device and a synchronization operation with the memory array and the internal memory are performed in the present disclosure. In such a way, the cost of the memory may be decreased and the power consumption of the memory device is reduced.

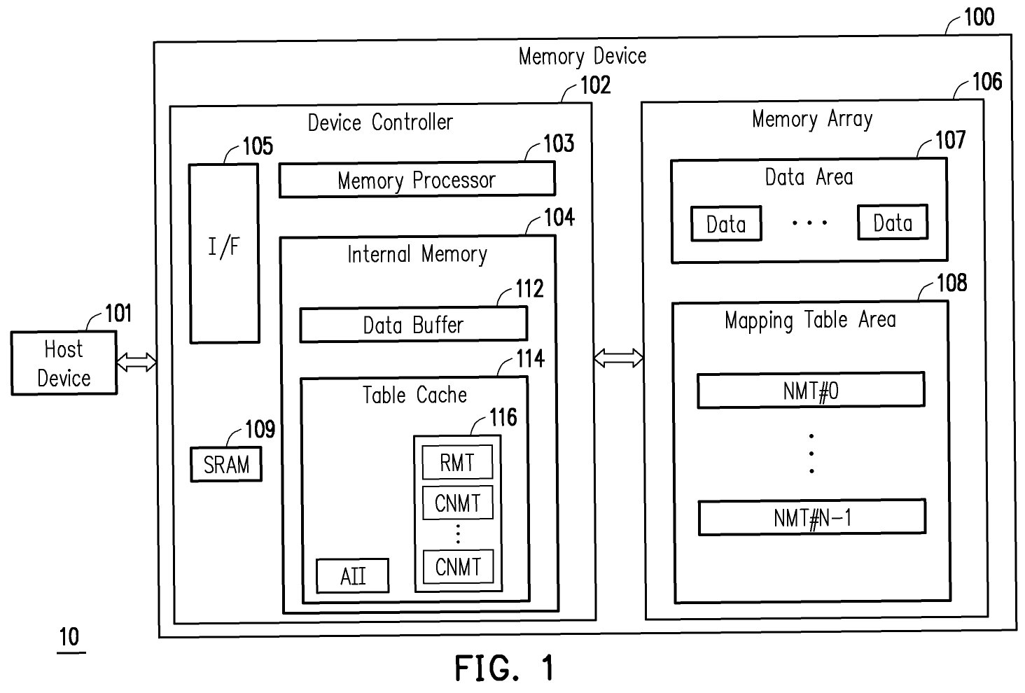

FIG. 1 is a block diagram of an electronic system 10 with a host device 101 and a memory device 100 according to an embodiment of the present invention. The electronic system 10 includes the host device 101 and the memory device 100. The memory device 100 includes a device controller 102 and a memory array 106. The device controller 102 includes a processor 103, an internal memory 104, and a host interface (I/F) 105, and may further include a Static Random Access Memory (SRAM) 109. The host interface 105 is an interface for the device controller 102 in communication with the host device 101. For example, through the host interface 105, the device controller 102 can receive write or read commands and data from the host device 101 or transmit user data retrieved from the memory array 130 to the host device 101. In some implementations, the memory device 100 is a storage device. For example, the memory device 100 can be an embedded multimedia card (eMMC), a secure digital (SD) card, a solid-state drive (SSD), or some other suitable storage. In some implementations, the memory device 100 is implemented in a smart watch, a digital camera or a media player. In some implementations, the memory device 100 is a client device that is coupled to a host device 101. For example, the memory device 100 is an SD card in a host device 101, such as a digital camera, a media player, a laptop or a personal computing device . . . etc.

The device controller 102 is a general-purpose microprocessor, or an application-specific microcontroller. In some implementations, the device controller 102 is a memory controller for the memory device 100. The following sections describe the various techniques based on implementations in which the device controller 102 is a memory controller. However, the techniques described in the following sections are also applicable in implementations in which the device controller 102 is another type of controller that is different from a memory controller. The processor 103 is coupled to the memory array 106 and the internal memory 104. The processor 103 is configured to execute instructions and process data. The instructions include firmware instructions and/or other program instructions that are stored as firmware code and/or other program code, respectively, in a secondary memory. The data includes program data corresponding to the firmware and/or other programs executed by the processor, among other suitable data. In some implementations, the processor 103 is a general-purpose microprocessor, or an application-specific microcontroller. The processor 103 is also referred to as a central processing unit (CPU). In some embodiment, the processor 103 may not only handle the algorithms of table caches and memory array, but also mange other flash translation layer (FTL) algorithm for assisting a memory array conversion of access addresses.

The processor 103 accesses instructions and data from the internal memory 104. In some implementations, the internal memory 104 is a Dynamic Random Access Memory (DRAM). In some implementations, the internal memory 104 is a cache memory that is included in the device controller 102, as shown in FIG. 1. The internal memory 104 stores data and mapping tables that are requested by the processor 103 during runtime. The SRAM 109 is operable to store instruction codes which correspond to the instruction codes executed by processor 103.

The device controller 102 transfers the instruction code and/or the data from the memory array 106 to the SRAM 109. In some implementations, the memory array 106 is a non-volatile memory (NVM) array that is configured for long-term storage of instructions and/or data, e.g., a NAND flash memory device, or some other suitable non-volatile memory device, and the memory device 100 is a NVM system. In implementations where the memory array 106 is NAND flash memory, the memory device 100 is a flash memory device, e.g., a solid-state drive (SSD), and the device controller 102 is a NAND flash controller.

The flash memory device (i.e., the memory device 100) has an erase-before-write architecture. To update a location in the flash memory device, the location must first be erased before new data can be written to it. The Flash Translation Layer (FTL) scheme is introduced in the flash memory device to manage read, write, and erase operations. The core of the FTL scheme is using a logical-to-physical address mapping table. If a physical address location mapped to a logical address contains previously written data, input data is written to an empty physical location in which no data were previously written. The mapping table is then updated due to the newly changed logical/physical address mapping. But, in the FTL scheme, all of the mapping table is uploaded to the internal memory 104, such that the capacity of internal memory 104 must larger than the size for all of the mapping table. Implementations of the present disclosure provide systems and methods for accessing data by a root mapping table to guide all node mapping tables is in the cached mapping table area of the internal memory or in the memory array. That is to say, a part of the cached node mapping tables is cached in the internal memory rather than all of the node mapping tables been cached in the internal memory, thus the capacity of the internal memory 104 in the memory device 100 may be shirked.

The memory array 106 in the embodiment of the present invention stores a plurality of node mapping tables (i.e., NMT#0-NMT#N−1 in FIG. 1) for accessing data in the memory array 106, and further stores a plurality of data. In some implementations, the memory array 106 has a data area 107 for storing the data and a mapping table area 108 for storing the node mapping tables NMT. In some implementations, multiple data DATA and the node mapping tables NMT are scatteredly stored in the memory array 106 (may implemented in other embodiments). Each of the data has a corresponding physical address and a corresponding logical address, and each of the node mapping tables NMT includes the corresponding physical address and corresponding logical address of the part of the data.

In the embodiment of the present invention, the internal memory 104 has a data buffer 112 and a cached mapping table area (i.e., a table cache 114). The memory controller 102 can buffer accessed data in the data buffer 112 of the internal memory 104. The cached mapping table area 116 is included in a part of the table cache 114 in the internal memory 104. In the embodiment of the present invention, the internal memory 104 has a root mapping table RMT loaded from the memory array 106, the root mapping table RMT is temporality stored in the cached mapping table area 116, and the cached mapping table area 116 also temporarily stores a part of the node mapping tables NMT#0-NMT#N−1 of the memory array 106. In other words, the table cache 114 can store a root mapping table RMT and the part of the mapping tables NMT#0-NMT#N−1 be cached (framed by a rectangle of the cached mapping table area 116). Each of the node mapping tables of FIG, 1 is as marked as CNMT. The table cache 114 further has an area for temporarily storing an asynchronous index identifier AII to synchronize the modified node mapping table(s) from the cached mapping table area 114 to the memory array 106.

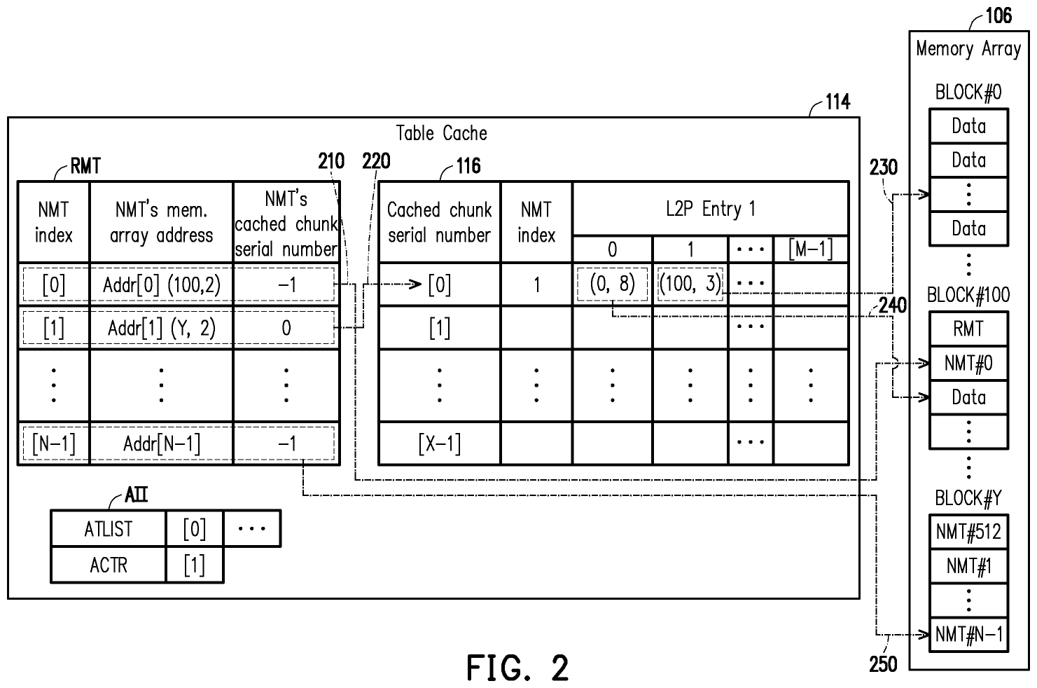

FIG. 2 is a schematic diagram of the root mapping table RMT, the cached NMT(s), the data structure of the memory array 106, and information of the asynchronous index identifier AII according to an embodiment of the present invention. In the embodiment, as for easy to description, it is assumed that the capacity of the memory array 106 is 512 GB, one of the NMTs can addresses 4 MB data, and the number for all of the NMTs in the memory array 106 is 131,072 (i.e., ‘N’=131,072). One of the NMTs has 1024 logic-to-physical (L2P) entries (i.e., ‘M’=1024). One L2P entry in the NMTs can address 4 KB data. The cached mapping table area 116 can accommodate 2048 cached NMTs as the maximum number (i.e., ‘X’=2,048). In other words, ‘N’ is the amount of the NMTs, ‘X’ is the amount for caching the NMTs in the cached mapping table area 116, and the ‘M’ is the amount of the L2P entries in one NMT. The number of ‘N’, ‘M’, ‘X’ is a positive integer. Those skilled in the embodiments can adjust the amount of the aforementioned data capacity as needed.

The root mapping table RMT is for guiding cached locations of the part of the node mapping tables temporarily stored in the cached mapping table area 116 and for guiding physical locations of the node mapping tables NMT#0-NMT#N−1 stored in the memory array 106. In detail, the root mapping table RMT includes three fields: ‘NMT index’, ‘NMT's memory address’, and ‘NMT's cached chunk serial number’. The ‘NMT index’ is referred as serial numbers of the NMTs in the memory array 106. The amount of the NMTs in the memory array 106 is N for example, N is positive integer. The ‘NMT's memory array address’ is referred as the physical address of the NMT. The ‘NMT's cached chunk serial number’ is referred to the NMT is been cached by the cached mapping table area 116 or not. In the embodiment, the NMT does not been cached while the number of the ‘NMT's cached chunk serial number’ is ‘−1’; and, the NMT been cached while the number of the ‘NMT's cached chunk serial number’ is a limited positive value, i.e., the limited positive value may be one of the value from ‘0’ to ‘X−1’.

In the embodiment, the cached mapping table area 116 is included in the internal memory 114. The cached mapping table area 116 includes three fields: ‘Cached chunk serial number’, ‘NMT index’, and ‘L2P entry’. The ‘Cached chunk serial number’ is referred as the serial number of each cached chunk, and the each cached chunk is to cache one NMT. In the embodiment, each row of the cached mapping table area 116 is one of the cached chunks. The ‘NMT index’ is referred as serial numbers of the NMTs in the memory array 106 and in the RMT. The ‘L2P entry’ is referred as the translation/mapping from one logical address of the data to one corresponding physical address of the data.

For example, referring to the first row of the RMT in FIG. 2, the ‘NMT index’ of first row is [0], and it means the serial number of the NMT is ‘0’ (marked as the NMT [0]). The ‘NMT's cached chunk serial number’ of the first row in the RMT is ‘−1’, and it means the NMT [0] does not been cached from the memory array 106 yet. Thus, if we want to access the NMT [0], it will first load the NMT#0 from the memory array 106 (as the arrow 210 shows) and get an empty row of the cached mapping table area 116 to temporarily store the NMT#0, and the above operation is according to the ‘NMT's memory address’ of first row in the RMT (i.e., Addr[0]). The arrow 210 shows that the NMT [0] is stored at a second location of the physical block BLOCK#100 in the memory array 106 (i.e., shown as NMT#0 of the memory array 106).

Referring to the second row of the RMT in FIG. 2, the ‘NMT index’ of second row is [1], and it means the serial number of the NMT is ‘1’. The ‘NMT's cached chunk serial number’ of the second row in the RMT is ‘0’, and it means the NMT has been cached from the memory array 106 (shown as ‘NMT's cached chunk serial number’ is addressing to the first row of the cached mapping table area 116). Thus, if we want to access the NMT [1], it can access the NMT [1] in the first row of the cached mapping table area 116 (shown as the arrow 220), and then access the data stored in the memory array 106 according to the L2P entries of the NMT [1] in the first row. For example, the first L2P entry ‘0’ of the NMT [1] is (0, 8), it means that the logic address of the data pointing to the first L2P entry ‘0’ of the NMT [1] is translated to the physical address (0, 8) of the data, and the data is stored in a eighth location of the physical block BLOCK#0 shown as the arrow 230. The second L2P entry ‘1’ of the NMT [1] is (100, 3), it means that the logic address of the data pointing to the second L2P entry ‘1’ of the NMT [1] is translated to the physical address (100, 3) of the data, and the data is stored in a third location of the physical block BLOCK#100 shown as the arrow 240.

Referring to the last row of the RMT in FIG. 2, the ‘NMT index’ of last row is [N−1], and it means the serial number of the NMT is ‘N−1’. The ‘NMT’ s cached chunk serial number' of the last row in the RMT is ‘−1’, and it means the NMT [N−1] does not been cached from the memory array 106 yet. The addr[N−1] in the ‘NMT's memory address’ of the RMT last row points to the last location of the physical block BLOCK#Y shown as the arrow 250.

In the process of data access between the host device 101 and the memory device 100, in order to reduce the number of writing operation to the memory array 106, the memory device 100 will first modify/adjust the NMTs cached in the cached mapping table area 116. And, in an appropriate situation (for example, the amount of the cached NMT is larger than a predefined threshold (e.g., the predefined threshold may be is 128), or a synchronization command is received), these modified/adjusted NMT(s) is/are written back to the memory array 106 for reducing the number of write operation of the memory array 106. The data synchronization of the NMTs between memory array 106 and memory device 100 is referred to as an synchronization operation. The asynchronous index identifier AII is used to record the information needed in the synchronization operation.

In the embodiment, referring to the asynchronous index identifier AII in the table cache of FIG. 2, the asynchronous index identifier AII includes an asynchronous table list ATLIST and an asynchronous counter ACTR. The asynchronous table list ATLIST stores serial number(s) of cached chunk(s) that caches the modified NMTs of the cached mapping table area 116 comparing with the NMT in the memory array 106. In the embodiments, the asynchronous table list ATLIST has one or more modified NMTs of the cached mapping table area 116, and data in these modified NMTs of the cached mapping table area 116 is not the same as the NMTs of the memory array 106, thus these modified NMTs of the cached mapping table area 116 is called “dirty NMT(s)”. The asynchronous counter ACTR is for counting a number of the cached chunk(s) that caches the modified NMTs. In other words, the asynchronous counter ACTR is the amount of the serial number(s) of cached chunk(s) in the asynchronous table list ATLIST. For example, referring to FIG. 2, because the cached NMT ‘1’ (the serial number of the cached chunk is [0]) has been modified, thus the processor 103 in FIG. 1 records the serial number of the cached chunk as [0] in the asynchronous table list ATLIST, and add one to the asynchronous counter ACTR from 0 to 1. After that, if there is another NMT is modified in one of the cached chunk (for example, the serial number of the cached chunk is [51]), then the processor 103 in FIG. 1 records the serial number of the cached chunk as [51] after [0] in the asynchronous table list ATLIST, and add one to the asynchronous counter ACTR from 1 to 2. In some embodiments, it is assumed that the asynchronous counter ACTR is 10, it has ten serial numbers of the cached chunk in the asynchronous table list ATLIST for presenting/recording ten cached NMTs (i.e., [0], [51], [102], [338], . . . ) have been modified.

In the embodiment, there are at least five operation can be performed with the asynchronous index identifier AII, that is, an ‘Insert’ operation, a ‘Search’ operation, a ‘Get’ operation, a ‘Delete’ operation, and a ‘Reset’ operation. In detail, the ‘Insert’ operation is to add the serial number of the cached chunk to the asynchronous table list ATLIST and to add one to the asynchronous counter ACTR. The ‘Search’ operation is to check/examine whether a wanted serial number of the cached chunk in the asynchronous table list ATLIST or not. The ‘Get’ operation is to get all of the asynchronous table list ATLIST. The ‘Delete’ operation is to remove one serial number of the cached chunk from the asynchronous table list ATLIST and to minus one to the asynchronous counter ACTR. The ‘Reset’ operation is to reset the asynchronous index identifier AII for clearing all of the asynchronous table list ATLIST and setting the asynchronous counter ACTR to zero. In the ‘Insert’ operation and the ‘Delete’ operation, it can be added/deleted the serial number of the cached chunk in the asynchronous table list ATLIST by First-in First-out (FIFO) or Sorting the serial number of the cached chunk (e.g. smallest to biggest, or biggest to smallest) as needed.

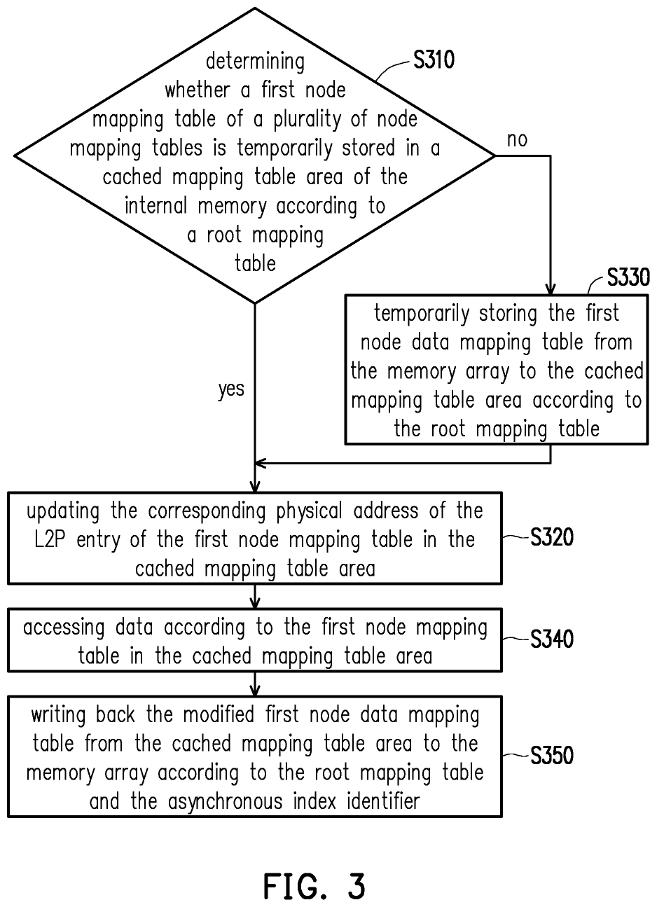

FIG. 3 is a flow chart illustrating a method for accessing the memory device 100 according to an embodiment of the present invention. Referring to FIG. 1 and FIG. 3, in step S310 of FIG. 3, the device controller 102 of the memory device 100 determines whether a first node mapping table of a plurality of node mapping tables is temporarily stored in a cached mapping table area 116 of the internal memory 104 according to a root mapping table RMT. The plurality of node mapping tables (e.g., NMT#0-NMT#N−1) is stored in the memory array 106, the root mapping table RMT is included in the internal memory 104, and the cached mapping table area 116 temporarily stores a part of the cached node mapping tables of the memory array 106. In other words, the cached mapping table area 116 does not temporarily store all of the node mapping tables NMT#0-NMT#X−1 in the memory array 106 at the same time.

If step S310 is YES (the first node data mapping table is temporarily stored in the cached mapping table area 114), it is performed to step S320, the processor 103 updates the corresponding physical address of the logic-to-physical (L2P) entry of the first node mapping table in the cached mapping table area 116.

If step S310 is NO (the first node data mapping table is not temporarily stored in the cached mapping table area 114, it is performed to step S330, the processor 103 temporarily stores the first node data mapping table from the memory array 106 to the cached mapping table area 116 according to the root mapping table RMT. In the step S330, if the cached mapping table area 116 has some empty cached chunks, the processor 103 determines one of the empty cached chunk in the cached mapping table area 116 for temporarily storing the first node data mapping table. Otherwise, if the cached mapping table area has no empty cached chunk for temporarily storing the first node data mapping table, the processor 103 selects and evicts one cached chunk from the cached mapping table area 116, and loads the first node data mapping table to the evicted cached chunk. Those skilled in the embodiments can use one of multiple swap map table algorithms to selectively evict one cached chunk from the cached mapping table area 116. These swap map table algorithms may include a Least Recently Used (LRU) algorithm, a Round Robin algorithm, a Round Rubin with weight algorithm, and etc., and these algorithms may be described below as examples.

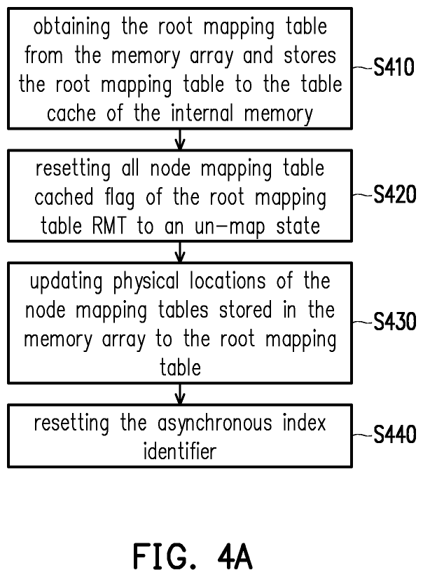

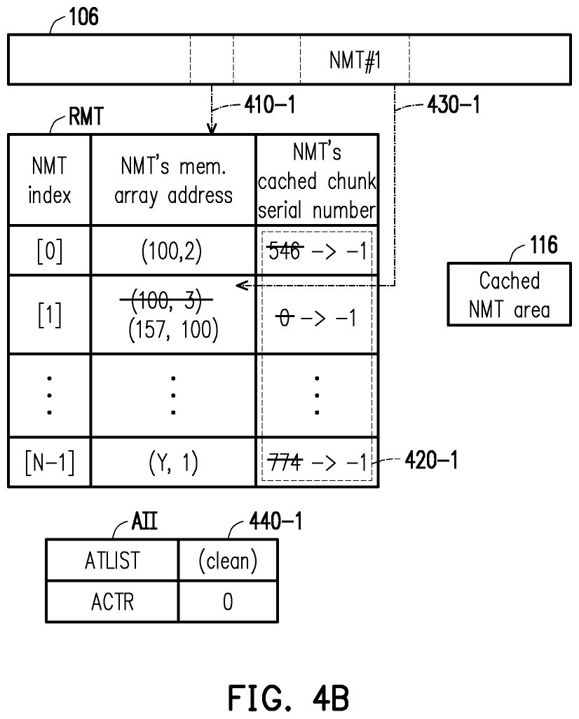

Referring back to FIG. 3, after the step S330, it is performed to the step S320. In step S320, the processor 103 updates the corresponding physical address of the logic-to-physical (L2P) entry of the first node mapping table in the cached mapping table area 116 according to the memory array 106. Detail steps of step S330 for updating the physical address of the L2P entry of the first node mapping table may refer to steps of FIGS. 4A and 4B. After the step S320, it is performed to the step S340. In step S340, the processor 103 accesses data according to the first node mapping table in the cached mapping table area. After the step S340, it is performed to the step S350.

In step S350, the processor 103 writes back the modified first node data mapping table from the cached mapping table area 116 to the memory array 106 according to the root mapping table RMT and the asynchronous index identifier AII while the first node data mapping table of the cached mapping table area 116 is modified. Detail operations of the step S310-S350 will described in following embodiments.

FIG. 4A and FIG. 4B is a flow chart and a schematic diagram for mapping table management initialization of the memory device 100 according to an embodiment of the present invention respectively. Referring to of FIGS. 4A and 4B, at first, while the memory device 100 is boot up or reset, the mapping table management initialization will be performed. In step S410, the processor 103 obtains the root mapping table RMT from the memory array 106 and stores the root mapping table RMT to the table cache 114 of the internal memory 104 (shown as an arrow 410-1). In other words, in step S410, the processor 103 finds the last root mapping table RMT of the memory array 106, and resides the last root mapping table RMT in the table cache 114 of the internal memory 104. In step S420, because that the S420 of FIG. 4A does not modify cached flag to cached chunk serial number yet, the processor 103 resets all node mapping table cached chunk serial number (i.e., ‘NMT's cached chunk serial number’) of the root mapping table RMT to an un-map state, that is, sets all of the ‘NMT’ s cached chunk serial number in the RMT to ‘−1’ shown as an rectangle 420-1. In step S430, the processor 103 updates the last root mapping table RMT according to physical locations of the node mapping tables NMTS stored in the memory array 106 but not synchronize to root mapping table RMT yet. For example, the processor 103 updates the physical location of the node mapping table NMT [1] from (100, 3) to (157, 100) shown as an arrow 430-1. In step S440, the processor 103 resets the asynchronous index identifier AII. For example, the processor 103 clears all of the asynchronous table list ATLIST to a clean state and sets the asynchronous counter ACTR to zero shown as rectangle 440-1. After performing steps S410-S440, the mapping table management initialization of the memory device 100 is end.

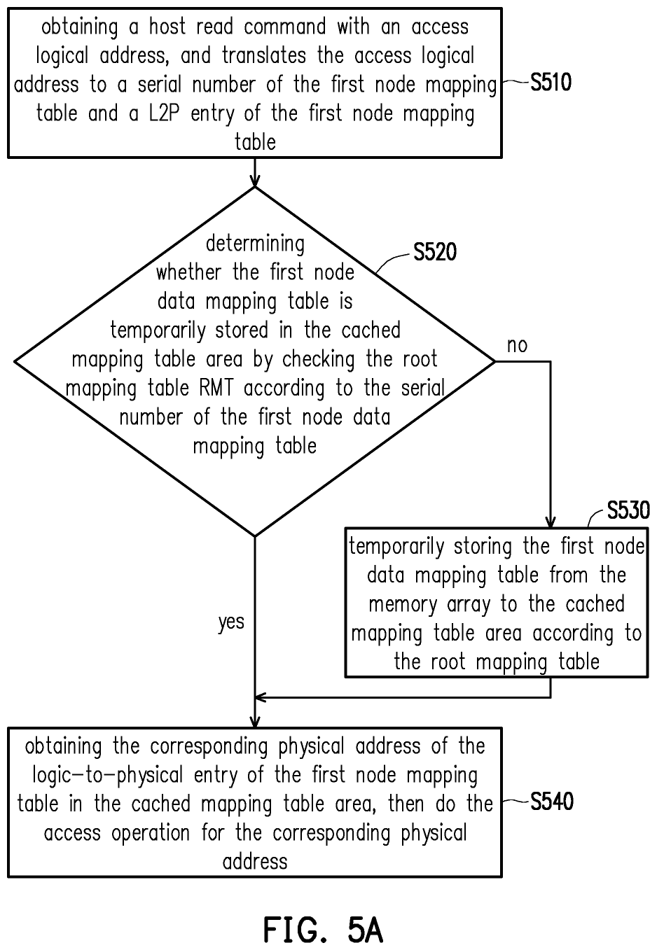

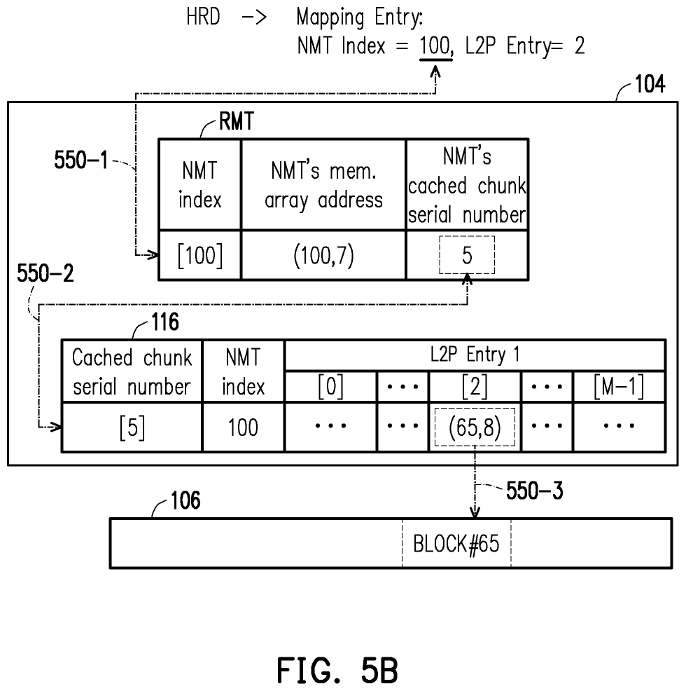

FIG. 5A and FIG. 5B is a flow chart and a schematic diagram for lookup L2P entry operation of the memory device 100 according to an embodiment of the present invention respectively. The lookup L2P entry operation may be subdivided into steps S510-S540. Referring FIG. 1, FIG. 5A, and FIG. 5B, in step S510, the processor 103 in FIG. 1 obtains a host read command HRD with an access logical address and translates the access logical address to a serial number of the first node mapping table and a logic-to-physical (L2P) entry of the first node mapping table. For example, the access logical address in the host read command HRD includes a logical block address (LBA) and a length of the host read command HRD. In detail, the LBA is a starting logical block address of the host read command HRD, and each unit of the logical block address is 512 Bytes. The access region of the host read command HRD is presented from the LBA (the starting logical block address) to an end logical block address equal to the LBA plus the length of the host read command HRD. The number of the LBA in the host read command HRD is 819296, and the number of the length is 8. Then, the processor 103 in FIG. 1 translates the access logical address (e.g., LBA=819296, length=8) in the host read command HRD to a serial number of the first node mapping table (e.g., ‘NMT index’=100) and a logic-to-physical (L2P) entry of the first node mapping table (e.g., ‘L2P Entry’=2) as a mapping entry. In step S520, the processor 103 in FIG. 1 determines whether the first node data mapping table is temporarily stored in the cached mapping table area 116 by checking the root mapping table RMT according to the serial number of the first node data mapping table. If the step S520 is YES (the first node data mapping table is temporarily stored in the cached mapping table area), then step S540 is performed after the step S520, the processor 103 obtains or gets the corresponding physical address of the corresponding logic-to-physical entry of the first node mapping table in the cached mapping table area 116 according to the cached NMT index (e.g., ‘NMT index’=100 as the serial number of the first node mapping table) to address target NMT, then do the access operation for the corresponding physical address.

For example, in FIG. 5B, the processor 103 translates the host read command HRD with the access logical address (e.g., LBA=819296, length=8) as the ‘100’ of the NMT index and the ‘2’ of the L2P Entry. Then, the processor 103 searches one row with ‘NMT index’ equal to

shown as an arrow 550-1, and then obtain the corresponding ‘NMT's cached chunk serial number’ is ‘5’, it means the cached NMT is located at one row with ‘Cached chunk serial number’ in the cached mapping table area 116 equal to ‘5’. The processor 103 searches the row with ‘Cached chunk serial number’ in the cached mapping table area 116 equal to ‘5’ according to the ‘NMT's cached chunk serial number’ of the RMT shown as an arrow 550-2, and obtains information in the second location ‘2’ of the L2P Entry as (65, 8), it means the physical location of the data is in eighth location of the physical block BLOCK#65 in the memory array 106 shown as an arrow 550-3.

If the step S520 is NO (the first node data mapping table is not temporarily stored in the cached mapping table area), then step S530 is performed after the step S520, the processor 103 temporarily stores the first node data mapping table from the memory array to the cached mapping table area according to the root mapping table RMT. In other words, in step S530, a swap map table operation is performed for selecting and evicting one cached chunk from the cached mapping table area 116, and loads the first node data mapping table to the evicted cached chunk as the demand NMT. And, the step S540 is performed after the step S530.

For other example of FIG. 2 and FIG. 5A, if the serial number of the first node mapping table is [1] (‘NMT index’ of RMT is [1]), then the processor 103 determines that the first row of the cached chunk in the cached mapping table area 116 is the first node mapping table (the step S520 is YES because the ‘NMT's cached chunk serial number’ is 0 and the ‘Cached chunk serial number’ of the NMT [1] in the cached mapping table area 116 is [0] shown by the arrow 220). Then, for example, the processor 103 translates the access logical address of the data pointing to the first L2P entry ‘0’ of the NMT [1] to the physical address (0, 8) of the data (the step S540) shown as the NMT [1] in the cached mapping table area 116, so as to obtain the corresponding physical address of the corresponding logic-to-physical entry of the first node mapping table in the cached mapping table area 116. If the serial number of the first node mapping table is [0] (‘NMT index’ of RMT is [0]), then the processor 103 determines that the first node mapping table does not been cached in the cached mapping table area 116 (the step S520 is NO because the ‘NMT's cached chunk serial number’ is −1). Thus, the processor 103 finds or selects one empty cached chunk on the cached mapping table area 116, temporarily stores the first node data mapping table from the memory array to the empty cached chunk of the cached mapping table area 116 according to the root mapping table RMT, and modifies the root mapping table RMT, such as, changes the ‘NMT's cached chunk serial number’ from ‘−1’ to the ‘Cached chunk serial number’ (e.g., ‘0’) to show the NMT has been cached.

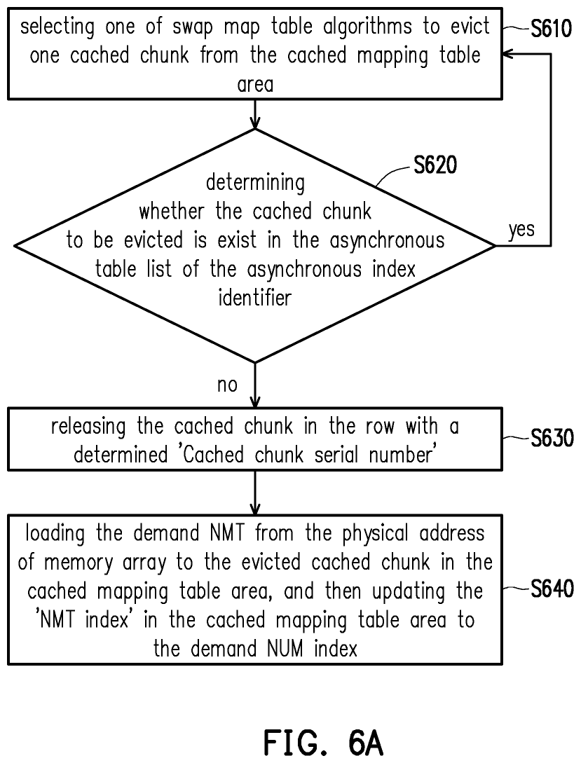

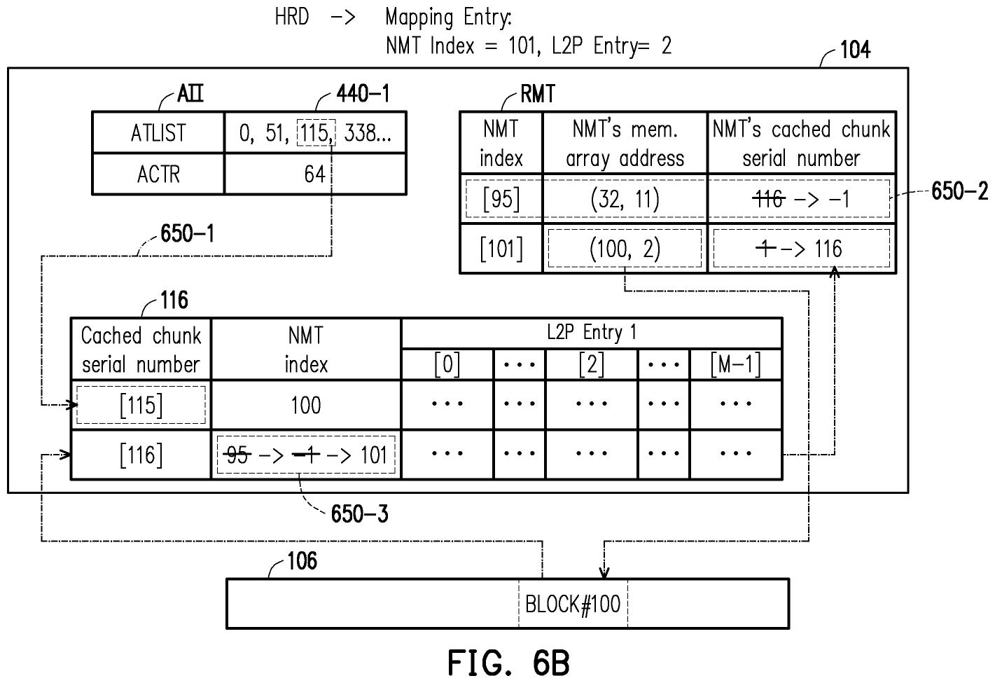

FIG. 6A and FIG. 6B is a flow chart and a schematic diagram for a swap map table operation of the memory device 100 according to an embodiment of the present invention. Referring to FIGS. 6A and 6B, in step S610, after translating the access logical address (e.g., LBA=827488, length=8) of the host read command HRD to a serial number of the first node mapping table (e.g., ‘NMT index’=101) and a L2P entry of the first node mapping table (e.g., ‘L2P Entry’=2) as a mapping entry, the processor 103 select one of swap map table algorithms to evict one cached chunk from the cached mapping table area as a victim candidate. The swap map table algorithms may include a Least Recently Used (LRU) algorithm, a Round Robin algorithm, a Round Rubin with weight algorithm, and etc. In step S620, the processor 103 determines whether the cached chunk to be evicted (e.g., the victim candidate) is exist in the asynchronous table list ATLIST of the asynchronous index identifier AII. If the Step S620 is YES, it means the cached chunk to be evicted already caches a NMT and the NMT already been modified and be recorded on the asynchronous table list ATLIST, and then the step S610 is needed to perform again for searching another cached chunk to be evicted. If the Step S620 is NO, it means the cached chunk to be evicted is empty, or the cached chunk to be evicted caches a NMT but the NMT does not been modified. In other words, the cached chunk to be evicted is ready to been evicted while the Step S620 is NO. For example, the number of ‘115’ is exist in the asynchronous table list ATLIST shown as an arrow 650-1, it means the NMT in the row with ‘115’ of ‘Cached chunk serial number’ in the cached mapping table area 116 has been modified. Thus, in the embodiment, we use the row with ‘116’ of ‘Cached chunk serial number’ as the cached chunk to be evicted.

In step S630, the cached chunk in the row with a determined ‘Cached chunk serial number’ (i.e., ‘116’) is released by the processor 103. In detail, the processor 103 sets the ‘NMT's cached chunk serial number’ from ‘116’ to ‘−1’ corresponding to the row with ‘95’ of ‘NMT index’ in the RMT and sets the corresponding ‘NMT index’ of the cached mapping table area 116 from ‘95’ to a UNMAP state (e.g., ‘−1’) corresponding to the row with ‘116’ of ‘Cached chunk serial number’ shown as a rectangle 650-3, so as to release the cached chunk in the row with ‘116’ of ‘Cached chunk serial number’. And, in step S640, the processor 103 loads the demand NMT from the physical address (e.g., (100, 8)) of memory array 106 to the evicted cached chunk in the cached mapping table area 116 (e.g., the row with [116] of ‘Cached chunk serial number’ in the cached mapping table area 116), and then updates the ‘NMT index’ of the row with [116] in the cached mapping table area 116 to the demand NUM index (e.g., ‘101’) shown as the rectangle 650-3.

If the processor 103 updates the physical location of the L2P entry in the NMT by the write operation, the cached NMT of the cached chunk in the cached mapping table area 116 is modified. And, the processor 103 inserts the corresponding cached index to asynchronous table list ATLIST of the asynchronous index identifier AII by using the ‘Insert’ operation for recording the new mapping relationship for modified NMT. In some implementations, if the amount of the cached NMT is larger than the predefined threshold (i.e., the asynchronous counter ACTR is larger than the predefined threshold), the processor 103 do a synchronize map table operation for writing the modified NMTs back to the memory array 106.

The Round Robin algorithm is described here for one example of the swap map table algorithms. The Round Robin algorithm is to select one cached chunk from the cached mapping table area for evicted. For example, if the storage capacity of the memory device 100 is 4 TB, it may need 512 MB storage capacity of the internal memory 104 for accessing the memory array 106, and the number of the cached chunk in the cached mapping table area 116 may become to 110,000. In the Round Robin algorithm, is sets a start pointer SP to point one of the cached chunk in the cached mapping table area 116, and if it needs to select one cached chunk in the cached mapping table area 116, the processor 103 evicts the cached chunk pointed by the start pointer SP, and then make the start pointer SP plus one for counting the start pointer SP cyclically with the cached chunk serial numbers. For example, while the start pointer SP is [x−1] of the cached chunk serial number, and then the start pointer SP pluses one to been the [0] of the cached chunk serial number for counting the start pointer SP cyclically. The advantage of the Round Robin algorithm is, every NMT just recently loaded to the cached mapping table area 116 does not be victim candidate to swap. But, it always need to reload the cached mapping table area 116 in a period if one of the cached chunk serial number is a dirty NMTs in the cached mapping table area 116 stored by the asynchronous index identifier AII.

The Least Recently Used (LRU) algorithm is described here for another one example of the swap map table algorithms. Operations of the LRU algorithm is to: recording a defined cache chunk amount as hotspot NMTs, wherein the number of the hotspot NMTs is the defined cache chunk amount; adding an accessed NMT to the head of the hotspot NMTs if it does not exist in these hotspot NMTs and the hotspot NMTs are not full; moving the accessed NMT to the head of the hotspot NMTs if it exists in these hotspot NMTs and the hotspot NMTs are not full; and, evicting the tail NMT of the hotspot NMTs if the hotspot NMTs is full and want to add a new NMT. Thus, the evicted NMT of the hotspot NMTs becomes the selected victim candidate. The selected victim candidate must not exist in the hotspot NMTs of the LRU algorithm. If the selected victim candidate exists in the hotspot NMTs, it performs the LRU algorithm again to evict the other tail NMT in the hotspot NMTs for re-selecting another victim candidate. The LRU algorithm can lock NMT cache chunks which are easy to reach higher temporal locality and higher spatial locality for frequent read/write commands, or current background operations. The selection order of the victim candidate may be the same with the Round Robin algorithm.

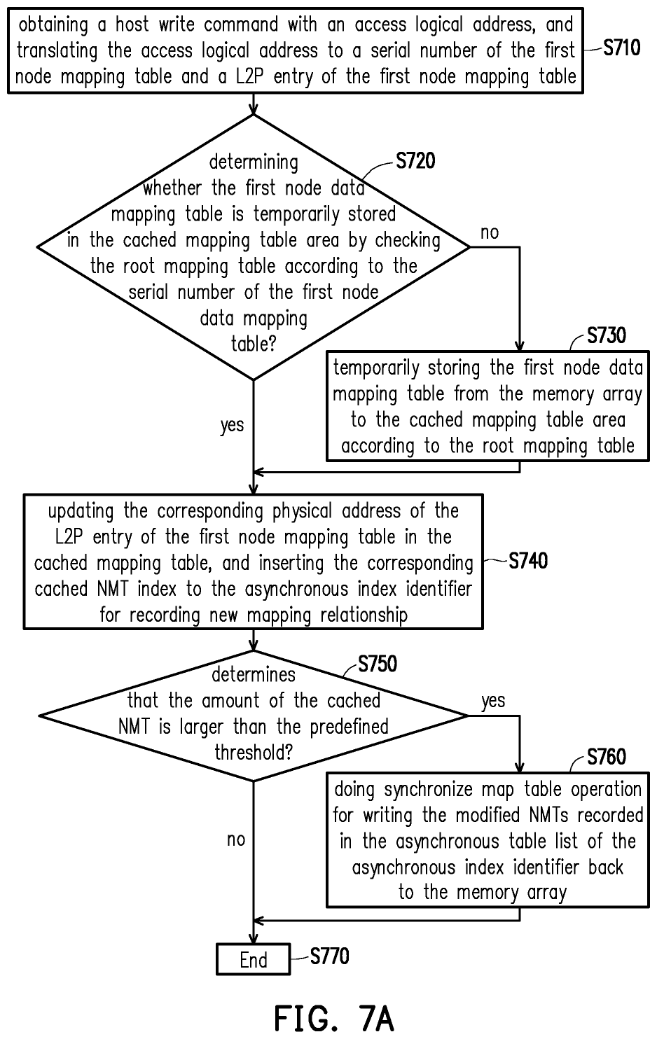

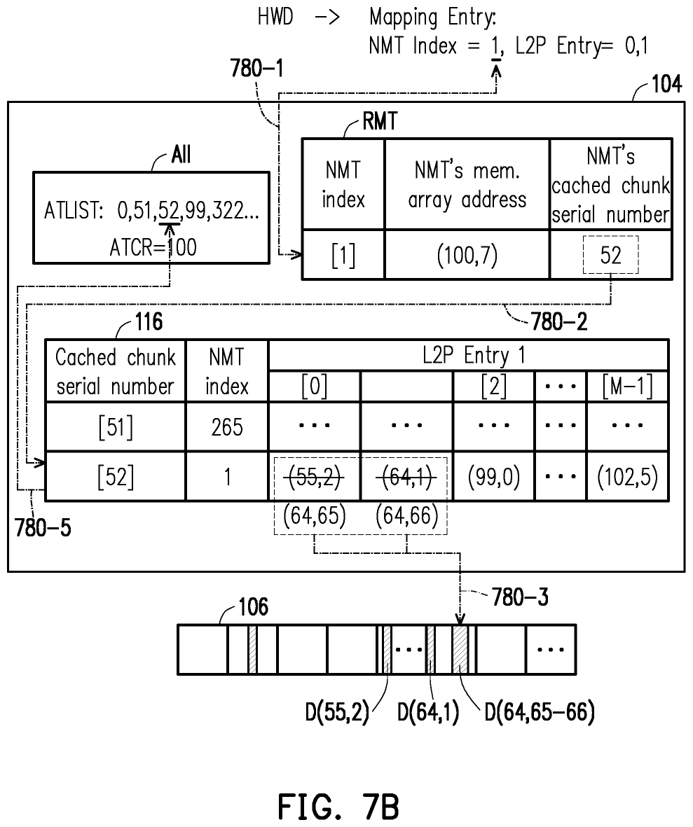

FIG. 7A and FIG. 7B is a flow chart and a schematic diagram for update L2P entry operation of the memory device 100 according to an embodiment of the present invention respectively. The update L2P entry operation is about the host write command HWD and the update L2P entry operation may be subdivided into steps S710-S770.

Referring FIG. 1, FIG. 7A, and FIG. 7B, in step S710, the processor 103 in FIG. 1 obtains a host write command HWD with an access logical address and translates the access logical address to a serial number of the first node mapping table and a L2P entry of the first node mapping table. For example, the access logical address in the host write command HWD includes a LBA (e.g., LBA=8208) and a length of the host write command HWD (e.g., length=16). In detail, the LBA is a starting logical block address of the host write command HWD, and each unit of the logical block address is 512 Bytes. The access region of the host write command HWD is presented from the LBA (the starting logical block address) to an end logical block address equal to the LBA plus the length of the host write command HWD. Then, the processor 103 in FIG. 1 translates the access logical address (LBA=8208, length=16) in the host write command HWD to a serial number of the first node mapping table (e.g., ‘NMT index’=1) and a L2P entry of the first node mapping table (e.g., ‘L2P Entry’=0, 1) as a mapping entry. As shown by arrow 780-1.

In step S720, the processor 103 in FIG. 1 determines whether the first node data mapping table is temporarily stored in the cached mapping table area 116 by checking the root mapping table RMT according to the serial number of the first node data mapping table. If the step S720 is YES (the first node data mapping table is temporarily stored in the cached mapping table area), then step S740 is performed after the step S720, the processor 103 updates the corresponding physical address of the L2P entry (e.g., ‘L2P Entry’=0, 1) of the first node mapping table in the cached mapping table area 116 according to the cached NMT index (e.g., ‘NMT index’=1 as the serial number of the first node mapping table) for updating target NMT, and the processor 103 further inserts the ‘NMT's cached chunk serial number’ (‘52’) of the corresponding cached NMT index (e.g., ‘NMT index’=1) to the asynchronous index identifier AII for recording new mapping relationship. On the contrary, if the S720 is NO (the first node data mapping table is not temporarily stored in the cached mapping table area), then step S730 is performed after the step S720, the processor 103 temporarily stores the first node data mapping table from the memory array to the cached mapping table area according to the root mapping table RMT. In other words, in step S730, a swap map table operation shown as FIGS. 6A and 6B is performed for selecting and evicting one cached chunk from the cached mapping table area 116, and loads the first node data mapping table to the evicted cached chunk as the demand NMT. And, the step S740 is performed after the step S730.

For example, in FIG. 7B, the processor 103 translates the host read command HRD with the access logical address (e.g., LBA=8208, length=16) as the ‘1’ of the NMT index and the ‘0’, ‘1’ of the L2P Entry in step S710 of FIG. 7A. Then, the processor 103 searches one row with NMT index’ equal to [1] shown as an arrow 780-1, and then obtain the corresponding ‘NMT's cached chunk serial number’ is ‘52’, it means the cached NMT is located at one row with ‘Cached chunk serial number’ in the cached mapping table area 116 equal to ‘52’. The processor 103 searches the row with ‘Cached chunk serial number’ in the cached mapping table area 116 equal to 152F according to the ‘NMT's cached chunk serial number’ of the RMT shown as an arrow 780-2 in ‘Yes” of step S720 in FIG. 7A. In step S740 of FIG. 7A, the processor 103 updates information in the location ‘0’ of the L2P Entry from (55, 2) to (64, 65), and updates information in the location ‘1’ of the L2P Entry from (64, 1) to (64, 66), shown as a rectangle 780-3, then writes data D(64, 65-66) to the corresponding physical locations (64, 65) and (64, 66) of the memory array 106 according to the locations ‘0’ and'1′ of the L2P Entry shown as an arrow 780-4. The original data D(55, 2) and D(64, 1) in corresponding physical locations (55, 2) and (64, 1) the memory array 106 became as invalid data. The processor 103 further inserts the ‘NMT's cached chunk serial number’ (‘52’) of the corresponding cached NMT index (e.g., ‘NMT index’=1) to the asynchronous index identifier AII shown as an arrow 780-5 in FIG. 7B, and make the asynchronous counter ACTR plus one to ‘100’ for recording new mapping relationship in step S740 of FIG. 7A.

In step S750 of FIG. 7A, the processor 103 determines that the amount of the cached NMT is larger than the predefined threshold or not (i.e., the asynchronous counter ACTR is larger than the predefined threshold). If step S750 is Yes, then step S760 is performed, the processor 103 do the synchronize map table operation for writing the modified NMTs recorded in the asynchronous table list ATLIST of the asynchronous index identifier AII back to the memory array 106. If step S750 is No or step S760 has been performed, then step S770 is performed, the processor 103 ends operations of the host write command HWD.

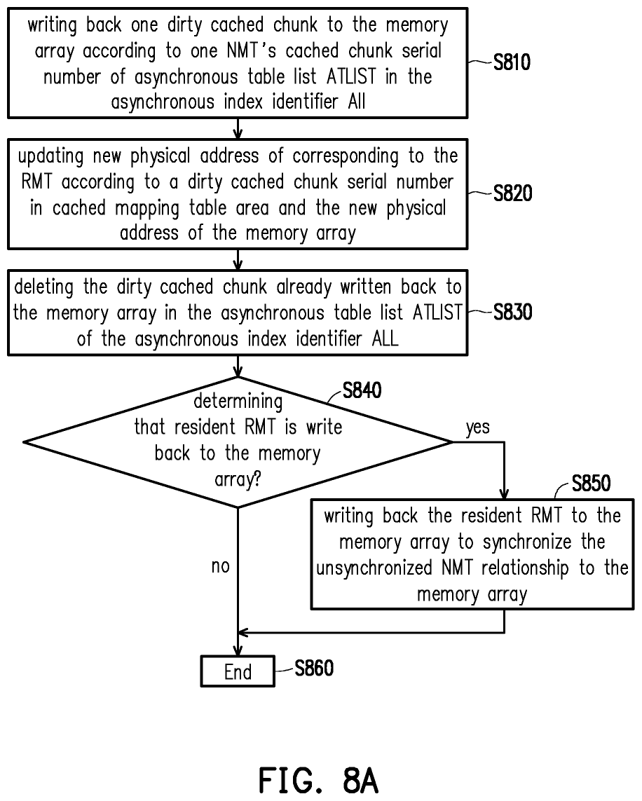

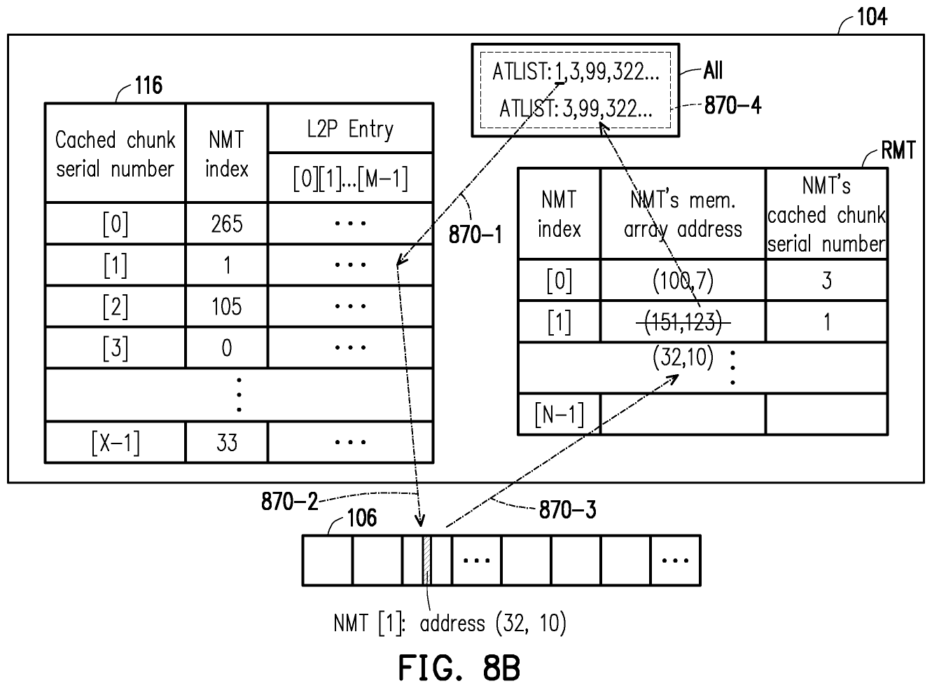

FIG. 8A and FIG. 8B is a flow chart and a schematic diagram for the synchronize map table operation of the memory device 100 according to an embodiment of the present invention. The synchronize map table operation is about step S760 of FIG. 7A and the synchronize map table operation may be subdivided into steps S810-S860.

Referring FIG. 1, FIG. 8A, and FIG. 8B, in step S810, the processor 103 writes back one dirty cached chunk (e.g., the NMT [1]) to the memory array 106 according to one ‘NMT's cached chunk serial number’ (e.g., ‘1’) of asynchronous table list ATLIST in the asynchronous index identifier AII. The arrow 870-1 of FIG. 8B presents the one ‘NMT's cached chunk serial number’ (e.g., ‘1’) of asynchronous table list ATLIST is pointed to the NMT [1] (e.g., the ‘Cached chunk serial number’ is [1]), and the arrow 870-2 of FIG. 8B presents information in the NMT [1] (e.g., information of the L2P entries in the NMT [1]) is write back to a new physical address (32, 10) of the memory array 106. In step S820 of FIG. 8A, the processor 103 updates the new physical address (e.g., (32, 10)) of corresponding NMT (the NMT [1]) to the RMT according to the dirty cached chunk serial number (e.g., [1]) in cached mapping table area 116 and the new physical address (32, 10) of the memory array 106. The arrow 870-3 of FIG. 8B presents the physical address (32, 10) of corresponding NMT (the NMT [1]) is updated to the ‘NMT's memory array address’ of the RMT. In step S830 of FIG. 8A, the processor 103 deletes the dirty cached chunk (e.g., the NMT [1]) already written back to the memory array 106 in the asynchronous table list ATLIST of the asynchronous index identifier AII shown as a rectangle 870-4. In step S840 of FIG. 8A, the processor 103 determines that resident RMT is write back to the memory array 106 or not. In some embodiments, the processor 103 may accumulate a defined NMT amount for writing back these NMTs recorded in the asynchronous table list ATLIST at the same time, or creates a new physical block for writing user data or these tables. If step S840 is Yes, step S850 is performed, the processor 103 writes back the resident RMT to the memory array 106 to synchronize the unsynchronized NMT relationship to the memory array 106. If step S840 is No or step S850 has been performed, then step S860 is performed, the processor 103 ends the synchronize map table operation.

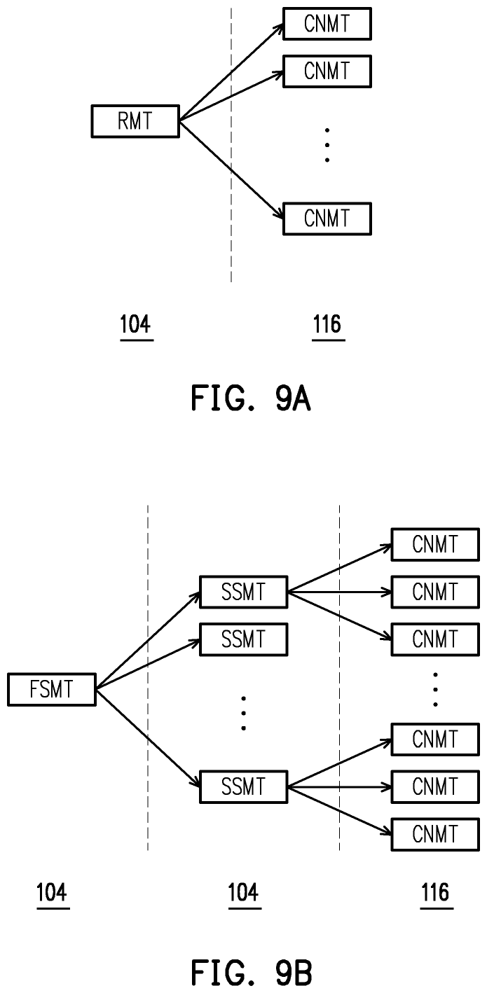

FIGS. 9A and 9B are schematic diagrams illustrating different structures of data mapping tables in the memory according to some embodiments of the present invention. In the above embodiments, the memory device 100 is implemented by two stages of mapping tables structure: a root mapping table RMT and multiple cached node mapping tables CNMT, presented as FIG. 9A. The root mapping table RMT is cached in the internal memory 104, and the cached node mapping tables CNMT is cached in cached mapping table area 116 of the internal memory 104. In some embodiments of the present invention, the memory device may by multiple stages of the mapping table structure, for example, three stages of mapping tables structure: a first stage mapping table FSMT, a plurality of second stage mapping tables SSMT, and multiple cached node mapping tables NMT, presented as FIG. 9B. In detail, the memory device as FIG. 9B may uses the first stage mapping table FSMT and the plurality of second stage mapping tables SSMT for implementing functions of the root mapping table RMT as FIG. 9A. In other words, the root mapping table includes a first stage mapping table FSMT and the plurality of second stage mapping tables SSMT. The first stage mapping table FSMT is for guiding cached locations of the second stage mapping tables SSMT. Each of the second stage mapping tables SSMT is for guiding cached locations of the part of the cached node mapping tables CNMT temporarily stored in the cached mapping table area 116 and for guiding physical locations of a part of the node mapping tables stored in the memory array 106. In the embodiment, the first stage mapping table FSMT and the second stage mapping tables SSMT may be cached in the internal memory 104, and the cached node mapping tables CNMT is cached in cached mapping table area 116 of the internal memory 104. Those skilled in the embodiments can adjust the amount of the stages of mapping tables structure as needed, and the amount of the stages is larger than or equal to 2.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A memory device, comprising:
a memory array, storing a plurality of node mapping tables for access data in the memory array;
an internal memory, including a cached mapping table area, and the internal memory has a root mapping table, wherein the cached mapping table area temporarily stores a part of the cached node mapping tables of the memory array; and
a processor coupled to the memory array and the internal memory,
wherein the processor determines whether a first node mapping table of the node mapping tables is temporarily stored in the cached mapping table area according to the root mapping table,
in response to the first node mapping table is temporarily stored in the cached mapping table area, the processor accesses data according to the first node mapping table in the cached mapping table area, and marks the modified first node mapping table through an asynchronous index identifier,
and, the processor writes back the modified first node mapping table from the cached mapping table area to the memory array according to the root mapping table and the asynchronous index identifier.

2. The memory device according to claim 1, wherein the memory array further storing a plurality of data, each of the data has a corresponding physical address and a corresponding logical address, and each of the node mapping tables includes the corresponding physical address and corresponding logical address of the part of the data.

3. The memory device according to claim 1, wherein the root mapping table is for guiding cached locations of the part of the cached node mapping tables temporarily stored in the cached mapping table area and for guiding physical locations of the node mapping tables stored in the memory array.

4. The memory device according to claim 1, wherein in response to the first node mapping table is not temporarily stored in the cached mapping table area, the processor temporarily stores the first node mapping table from the memory array to the cached mapping table area according to the root mapping table.

5. The memory device according to claim 1, wherein the asynchronous index identifier includes:
an asynchronous table list, storing a serial number of the modified first node mapping table; and
an asynchronous counter, counting a number of modified first node mapping table.

6. The memory device according to claim 5, wherein in response to the asynchronous counter is larger than a predefined threshold, the processor writes back the modified first node mapping table from the cached mapping table area to the memory array according to the root mapping table and the asynchronous index identifier, and
the processor clears the asynchronous table list and sets the asynchronous counter to zero after writing back the modified first node mapping table to the memory array.

7. The memory device according to claim 1, wherein the processor is further configured to:
obtaining the root mapping table from the memory array and storing the root mapping table to the internal memory;
resetting all node mapping table cached index of the root mapping table to an un-map state;
updating the physical locations of the node mapping tables stored in the memory array to the root mapping table; and
resetting the asynchronous index identifier.

8. The memory device according to claim 7, wherein the processor is further configured to:
obtaining an access logical address, and translating the access logical address to a serial number of the first node mapping table and a logic-to-physical entry of the first node mapping table;
determining whether the first node mapping table is temporarily stored in the cached mapping table area by checking the root mapping table according to the serial number of the first node mapping table;
in response to the first node mapping table is temporarily stored in the cached mapping table area, obtaining the corresponding physical address of the logic-to-physical entry of the first node mapping table in the cached mapping table area; and
in response to the first node mapping table is not temporarily stored in the cached mapping table area, temporarily storing the first node mapping table from the memory array to the cached mapping table area according to the root mapping table.

9. The memory device according to claim 8, wherein the processor is further configured to:
determining the cached mapping table area has an empty cached chunk for temporarily storing the first node mapping table; and
in response to the cached mapping table area has no empty cached chunk for temporarily storing the first node mapping table, evicting one cached chunk from the cached mapping table area and loading the first node mapping table to the evicted cached chunk.

10. The memory device according to claim 9, wherein the processor uses one of swap map table algorithms to evict one cached chunk from the cached mapping table area,
wherein the swap map table algorithms includes a least recently used (LRU) algorithm, a round robin algorithm, and a round Rubin with weight algorithm.

11. The memory device according to claim 1, wherein the memory array is a NAND flash memory array.

12. The memory device according to claim 1, wherein the internal memory is a dynamic random access memory (DRAM).

13. The memory device according to claim 1, wherein the cached mapping table area does not temporarily store all of the node mapping tables in the memory array at the same time.

14. The memory device according to claim 1, the root mapping table includes:
a first stage mapping table; and
a plurality of second stage mapping tables,
wherein the first stage mapping table is for guiding cached locations of the second stage mapping tables, and each of the second stage mapping tables is for guiding cached locations of the part of the cached node mapping tables temporarily stored in the cached mapping table area and for guiding physical locations of a part of the node mapping tables stored in the memory array.

15. A method for accessing a memory device, wherein the memory device includes a memory array and an internal memory, the method comprising:
determining whether a first node mapping table of a plurality of node mapping tables is temporarily stored in a cached mapping table area of the internal memory according to a root mapping table, wherein the plurality of node mapping tables is stored in the memory array, the root mapping table is included in the internal memory, and the cached mapping table area temporarily stores a part of the cached node mapping tables of the memory array;
in response to the first node mapping table is temporarily stored in the cached mapping table area, accessing data according to the first node mapping table in the cached mapping table area;
marking the modified first node mapping table through an asynchronous index identifier; and
writing back the modified first node mapping table from the cached mapping table area to the memory array according to the root mapping table and the asynchronous index identifier.

16. The method for accessing the memory device according to claim 15, wherein the memory array further storing a plurality of data, each of the data has a corresponding physical address and a corresponding logical address, and each of the node mapping tables includes the corresponding physical address and corresponding logical address of the part of the data.

17. The method for accessing the memory device according to claim 15, wherein the root mapping table is for guiding cached locations of the part of the cached node mapping tables temporarily stored in the cached mapping table area and for guiding physical locations of the node mapping tables stored in the memory array.

18. The method for accessing the memory device according to claim 15, further comprising:
in response to the first node mapping table is not temporarily stored in the cached mapping table area, temporarily storing the first node mapping table from the memory array to the cached mapping table area according to the root mapping table.

19. The method for accessing the memory device according to claim 15, wherein the asynchronous index identifier includes:
an asynchronous table list, storing a serial number of the modified first node mapping table; and
an asynchronous counter, counting a number of modified first node mapping table.

20. The method for accessing the memory device according to claim 19, further comprising:
in response to the asynchronous counter is larger than a predefined threshold, writing back the modified first node mapping table from the cached mapping table area to the memory array according to the root mapping table and the asynchronous index identifier, and
clearing the asynchronous table list and resetting the asynchronous counter to zero after writing back the modified first node mapping table to the memory array.

21. The method for accessing the memory device according to claim 15, further comprising:
obtaining the root mapping table from the memory array and storing the root mapping table to the internal memory;
resetting all node mapping table cached index of the root mapping table to an un-map state;
updating the physical locations of the node mapping tables stored in the memory array to the root mapping table; and
resetting the asynchronous index identifier.

22. The method for accessing the memory device according to claim 15, further comprising:
obtaining an access logical address, and translating the access logical address to a serial number of the first node mapping table and a logic-to-physical entry of the first node mapping table;
determining whether the first node mapping table is temporarily stored in the cached mapping table area by checking the root mapping table according to the serial number of the first node mapping table;
in response to the first node mapping table is temporarily stored in the cached mapping table area, obtaining the corresponding physical address of the logic-to-physical entry of the first node mapping table in the cached mapping table area; and
in response to the first node mapping table is not temporarily stored in the cached mapping table area, temporarily storing the first node mapping table from the memory array to the cached mapping table area according to the root mapping table.

23. The method for accessing the memory device according to claim 22, further comprising:
determining the cached mapping table area has an empty cached chunk for temporarily storing the first node mapping table; and
in response to the cached mapping table area has no empty cached chunk for temporarily storing the first node mapping table, evicting one cached chunk from the cached mapping table area and loading the first node mapping table to the evicted cached chunk.

24. The method for accessing the memory device according to claim 23, one cached chunk from the cached mapping table area is evicted by using one of swap map table algorithms to evict one cached chunk from the cached mapping table area,
wherein the swap map table algorithms includes a least recently used (LRU) algorithm, a round robin algorithm, and a round Rubin with weight algorithm.

25. The method for accessing the memory device according to claim 15, wherein the memory array is a NAND flash memory array, the internal memory is a dynamic random access memory (DRAM), and the cached mapping table area does not temporarily store all of the node mapping tables in the memory array at the same time.

26. A method for accessing a memory device, comprising:
determining whether a first node mapping table of a plurality of node mapping tables is temporarily stored in a cached mapping table area of an internal memory according to a root mapping table, wherein the plurality of node mapping tables is stored in a memory array of the memory device, and the root mapping table is included in the internal memory, and the cached mapping table area does not temporarily store all of the node mapping tables in the memory array at the same time;
in response to the first node mapping table is temporarily stored in the cached mapping table area, accessing data according to the first node mapping table in the cached mapping table area; and
synchronizing the modified first node mapping table from the cached mapping table area to the memory array.

27. The memory according to claim 26, wherein the step for synchronizing the modified first node mapping table from the cached mapping table area to the memory array comprising:
marking the modified first node mapping table through an asynchronous index identifier; and
writing back the modified first node mapping table from the cached mapping table area to the memory array according to the root mapping table and the asynchronous index identifier.
